(19) United States
(12) Patent Application Publication
(10) Pub. No.: US 2020/0188823 A1
(43) Pub. Date: Jun. 18, 2020

(54) WATER-PURIFYING LID HAVING SELF-POWERED UV LED AND FILTER COUPLED THERETO

(71) Applicant: Hwan Jong OH, Wonju-si (KR)

(72) Inventor: Hwan Jong OH, Wonju-si (KR)

(21) Appl. No.: 16/349,571

(22) PCT Filed: Nov. 15, 2016
(86) PCT No.: PCT/KR2016/013127

§ 371 Date: May 13, 2019

(30) Foreign Application Priority Data
Nov. 14, 2016 (KR) 10-2016-0150836

(51) Int. Cl. B01D 35/06; C02F 1/32; C02F 1/00

(52) U.S. Cl. CPC B01D 35/06; C02F 1/325; C02F 1/002; C02F 2307/02; C02F 2201/009; C02F 2201/3222; C02F 2303/04

(57) ABSTRACT

The present invention relates to a water-purifying lid having a self-powered UV LED and a filter coupled thereto, the lid comprising: a first body having a box shape and open at one end thereof; a support plate installed in an inner space of the first body to form a space; a rotational part; a coil part; a handle coupled to one end of a rotational shaft at one end thereof so as to rotate the rotational shaft when a force is applied thereto; an ultraviolet sterilization device; a second body; a filter for removing impurities; and a discharge part comprising a valve, wherein a user rotates the rotational shaft and a rotational plate by using the handle, a magnet moves above the coil part with the rotation of the rotational plate to generate electricity at the coil part, and the electricity having been generated at the coil part is transferred to a UV LED of the sterilization device, thereby emitting an ultraviolet ray which sterilizes water in the second body.

### TECHNICAL FIELD

The present invention relates to a water-purifying lid having a self-powered ultraviolet UV LED and a filter coupled thereto, which is coupled to a container capable of storing drinkable water to discharge the drinkable water after sterilizing and purifying the drinkable water.

### BACKGROUND ART

Nowadays, the main cause of the deaths in the world is a water-borne disease. The populations of more than 2.3 billion are suffering from the diseases related to water and about 300 millions of people are suffering from dangerous diseases, and 2.2 millions of people, in particular, of children of less than five years old die every year (UN Task Force Water and Sanitary Facilities 2003). Almost of them live with less than 2 dollars every day, and the range of the technologies which may be provided to them for purification of water is extremely limited.

At the same time, the worldwide nations use many of the freshwater sources every year, and the possibility of obtaining safe drinkable water and the necessity for an efficient water purifying system are increasing. The UN population funds predict that 5 billion populations of the 7.9 billion populations in 2025 will live in the areas which lack safe water. The more unsatisfied demands on freshwater are requested in the developing countries. The average water consumption per one person in the developing countries is 2 gallons (7.7 liters) per person every day.

Many natural freshwater sources on the earth are contaminated by water-borne pathogenic bacteria. The lakes, the rivers, and the creeks in the world include bacteria, viruses, and protozoa that may generally cause severe health problems. The wells and the tube wells generally used as the freshwater sources in the world may be contaminated by the underground water in the rainy season in many areas of the world when the water-borne pathogenic bacteria are introduced into surface water, contaminating the wells. If the tube wells are badly constructed and badly maintained, the contaminated ground water may permeate into the wells on the more normal basis.

In order to utilize the contaminated water, many water purifying technologies range from the simple and inexpensive ones to the very complex and expensive ones are present, and the effect levels of the processing of the water-borne pathogenic bacteria, the organic contaminants, and the inorganic contaminants are distributed in a wide range. One simple and general technology is to boil water. In several areas of the world, because boiling requires a considerable amount of energy and the water is heated for a very short time, for which the water-borne pathogenic bacteria cannot be deactivated or sterilized, or has a possibility of not being heated until the water is completely boiled, it is not practical to be used every day. Further, among the conventional water purifying systems, the prices per gallon of the many products are too high so that the products cannot be actually used in the developing countries.

### DETAILED DESCRIPTION OF THE INVENTION

### Technical Problem

The present invention has been suggested to solve the above-mentioned problems, and provides a water-purifying lid having a self-powered UV LED and a filter coupled thereto, which can easily sterilize and purify the water by coupling a device for emitting UV rays and a filter to the lid which blocks an inlet of a drinkable water container, and is economical because separate costs for producing electrical energy are not required by allowing the device which emits UV rays to receive electricity and emit light through self-powered generation.

### Technical Solution

In order to achieve the above-mentioned objects, the present invention provides a water-purifying lid having a UV LED and a filter coupled thereto, and more particularly to a water-purifying lid having a self-powered UV LED and a filter coupled thereto, the water-purifying lid being usable for an apparatus for sterilizing water contained in a container such that the water is drinkable when the water is discharged, the water-purifying lid including: a first body, which has a box shape and one end of which is opened; a support plate installed in an inner space of the first body to form a space; a rotation unit including a rotary shaft which is installed in the interior of the first body to be rotated by an external force, and one end of which passes through an opposite end of the first body and is coupled to the opposite end of the first body to be rotatable and an opposite end of which is coupled to the support plate to be rotatable, a rotary plate being a plate-shaped member, installed on one side of the rotary shaft, and rotated according to rotation of the rotary shaft, and a magnet installed on an outer surface of the rotary plate; a coil unit installed in the support plate such that a coil is wound thereon to have a predetermined shape, and configured to generate electricity as a magnetic force is changed by the magnet; a handle, one end of which is coupled to the one end of the rotary shaft and configured to apply a force such that the rotary shaft is rotated; a sterilization device, which emits heats such that UV rays are discharged after the electricity generated by the coil unit is transferred to the UV LED and one end of which is coupled to the support plate; a second body, which has a discharge hole, through which water is discharged, on one side of an outer peripheral surface thereof, which has a pipe shape, opposite ends of which are opened, and one end of which is coupled to an inlet of the container filled with the water and an opposite end of which is coupled to the one end of the first body such that the sterilization device is located in the inner space; a filter installed in a hole at one end of the second body and configured to remove impurities when the water in the container flows into the second body; and a discharge unit, one end of which is coupled to the discharge hole such that the water sterilized in the second body is discharged by movement of a valve installed on one side thereof, wherein the water discharged from the container filled with the water is discharged to the discharge unit after the water is sterilized by the sterilization device while the impurities are filtered by the filter, a user rotates the rotary shaft and the rotary plate with the handle, and the magnet moves above the coil unit according to rotation of the rotary plate such that the coil unit generates electricity, and the electricity generated by the coil unit is transferred to the UV LED of the sterilization device such that the UV rays for sterilizing the water in the interior of the second body is emitted.

### Advantageous Effects of the Invention

The present invention having the above-mentioned configuration has the following effects.

First, according to the present invention, because the filter capable of physically removing the impurities is coupled to the lid, the impurities can be removed when the water in the water container is discharged through the lid, and the water can be easily purified by operating the UV LEDs, which are coupled to the lid, when the water is discharged through the lid. That is, according to the present invention, because the water-purifying lid having a self-powered UV LED and a filter coupled thereto is coupled to the container filled with the water, the discharged water can be processed physically and chemically and be converted to drinkable water so that people can easily drink water in underdeveloped nations, such as African countries, which undergo hunger.

Second, according to the present invention, the user can directly generate electricity to allow the UV LEDs to emit light, and thus is economical because separate costs for producing electrical energy are not required. That is, because the UV LEDs can emit light through self-powered generation by using manpower, separate costs for allowing the UV LEDs to emit light are not required. Accordingly, the present invention is an invention which helps drink clear water with low costs in the underdeveloped nations, such as African countries, which undergo hunger.

Third, according to the present invention, because the water flowing from the container into the lid becomes turbulent, a sterilization effect by the UV LEDs is high.

### DESCRIPTION OF THE DRAWINGS

FIG. 1 is a perspective view of a lid according to the present invention.

FIG. 2 is an exploded perspective view of FIG. 1.

FIG. 3 is an exploded perspective view of a first body.

FIG. 4 is a perspective view illustrating the interior of FIG. 1.

FIG. 5 is a side view of FIG. 1.

FIG. 6 is a view illustrating that a third body, which is to be coupled to a second body, is selected according to the size of an inlet of a container.

FIG. 7 is a side view illustrating that a rotation unit and a coil unit are installed in the first body.

FIG. 8 is a side view illustrating that only one rotation unit and two coil units are installed in the first body.

FIG. 9 is a view illustrating the lid according to the present invention is coupled to the container filled with water.

- Description of reference numerals -

| | | | |
|---|---|---|---|
| 10: | Lid | 20: | Container |
| 100: | First body | | |
| 150: | Second body | 151: | Discharge hole |
| 152: | Observation hole | 153: | Transparent plate |
| 170: | Third body | | |
| 200: | Support plate | | |
| 300: | Rotation unit | 310: | Rotary shaft |
| 320: | Rotary plate | 330: | Magnet |
| 400: | Coil unit | 450: | Storage battery |
| 500: | Handle | | |
| 600: | Sterilization device | | |
| 610: | Light emitting body | 620: | Light emitter plate |
| 700: | Filter | 810: | Valve |
| 800: | Discharge unit | | |
| 900: | Controller | | |

### BEST MODE

Hereinafter, detailed contents of a water-purifying lid having a self-powered ultraviolet (UV) LED and a filter coupled thereto will be described in detail with reference to the accompanying drawings.

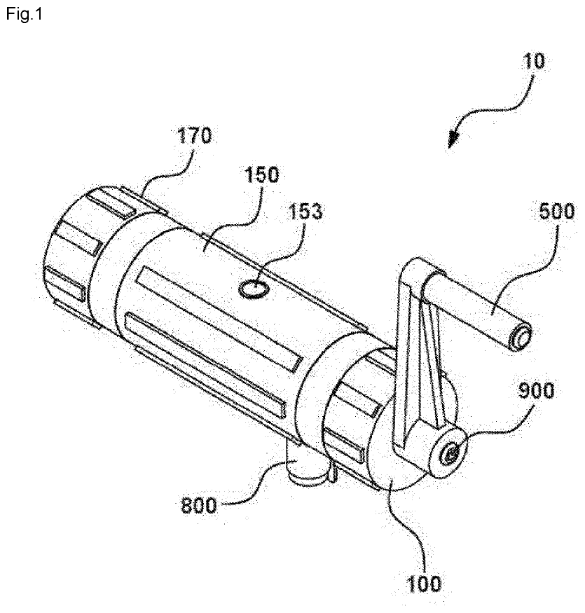

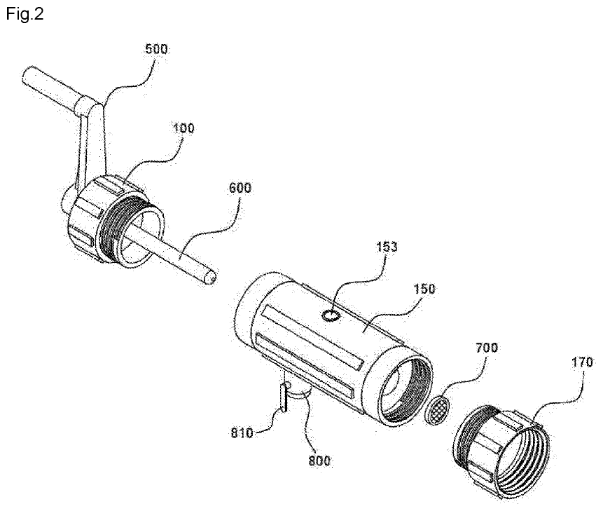

FIG. 1 is a perspective view of a lid according to the present invention. FIG. 2 is an exploded perspective view of FIG. 1.

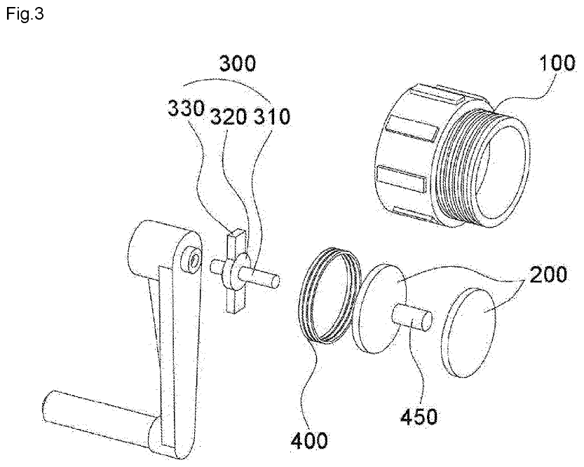

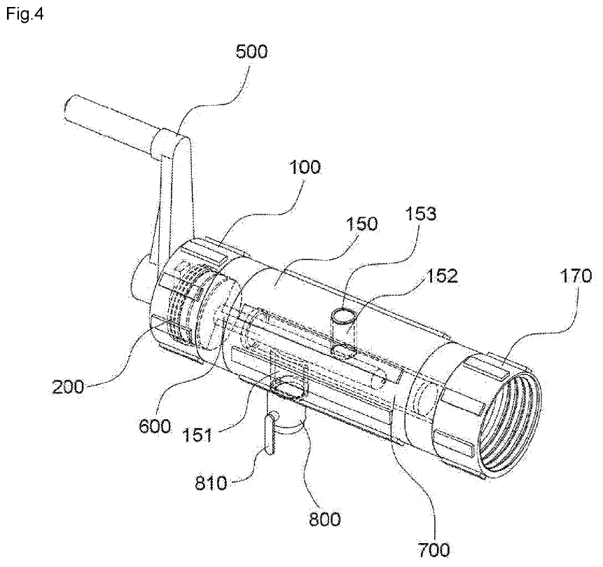

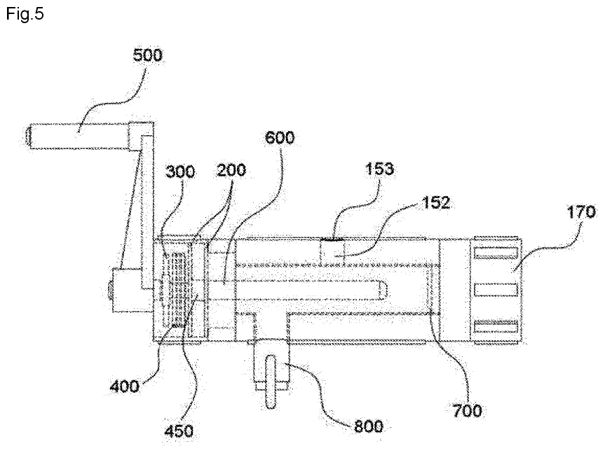

FIG. 3 is an exploded perspective view of a first body. FIG. 4 is a perspective view illustrating the interior of FIG. 1. FIG. 5 is a side view of FIG. 1.

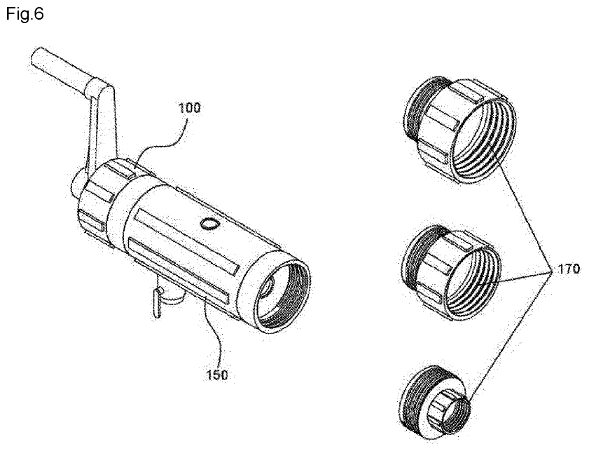

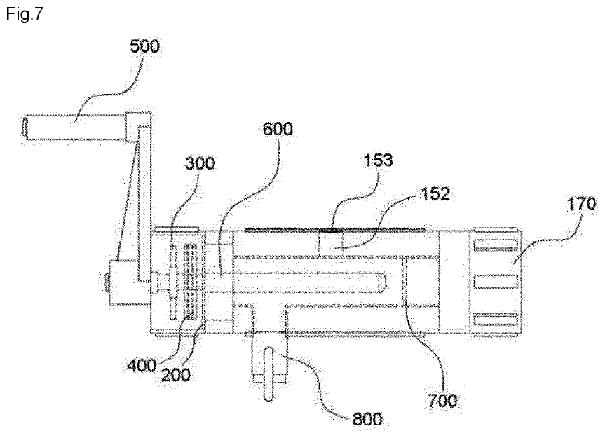

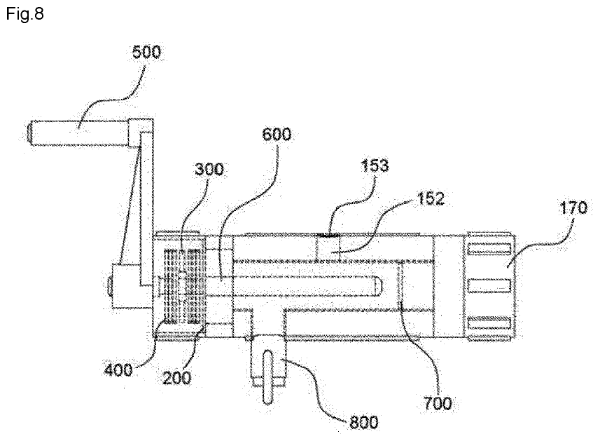

FIG. 6 is a view illustrating that a third body, which is to be coupled to a second body, is selected according to the size of an inlet of a container. FIG. 7 is a side view illustrating that a rotation unit and a coil unit are installed in the first body. FIG. 8 is a side view illustrating that only one rotation unit and two coil units are installed in the first body.

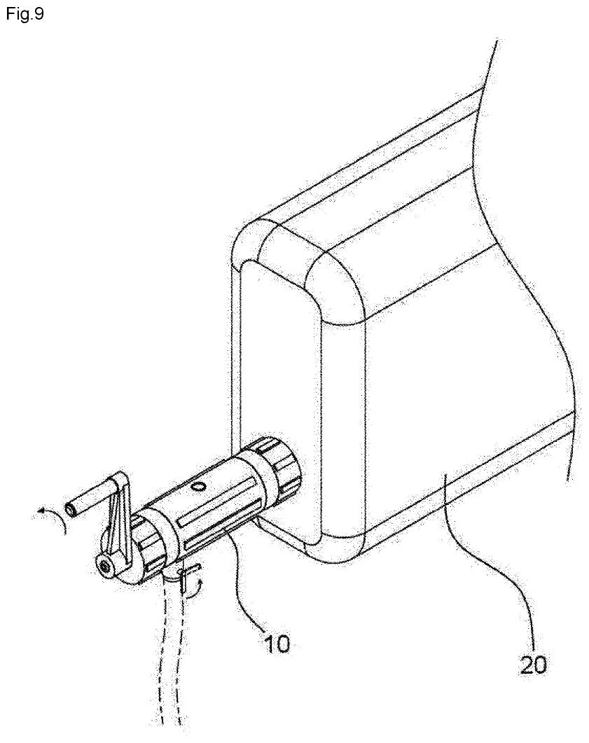

FIG. 9 is a view illustrating the lid according to the present invention is coupled to the container filled with water.

The present invention relates to a water-purifying lid having a self-powered ultraviolet (UV) LED and a filter coupled thereto, and more particularly to a water-purifying lid having a self-powered UV LED and a filter coupled thereto, the water-purifying lid being usable for an apparatus for sterilizing water contained in a container such that the water is drinkable when the water is discharged, the water-purifying lid including: a first body 100, which has a box shape and one end of which is opened; a support plate 200 installed in an inner space of the first body 100 to form a space; a rotation unit 300 including a rotary shaft 310 which is installed in the interior of the first body 100 to be rotated by an external force, and one end of which passes through an opposite end of the first body 100 and is coupled to the opposite end of the first body 100 to be rotatable and an opposite end of which is coupled to the support plate 200 to be rotatable, a rotary plate 320 being a plate-shaped member, installed on one side of the rotary shaft 310, and rotated according to rotation of the rotary shaft 310, and a magnet 330 installed on an outer surface of the rotary plate 320; a coil unit 400 installed in the support plate 200 such that a coil is wound thereon to have a predetermined shape, and configured to generate electricity as a magnetic force is changed by the magnet 330; a handle 500, one end of which is coupled to the one end of the rotary shaft 310 and configured to apply a force such that the rotary shaft 310 is rotated; a sterilization device 600, which emits heats such that UV rays are discharged after the electricity generated by the coil unit 400 is transferred to the UV LED and one end of which is coupled to the support plate 200; a second body 150, which has a discharge hole 151, through which water is discharged, on one side of an outer peripheral surface thereof, which has a pipe shape, opposite ends of which are opened, and one end of which is coupled to an inlet of the container filled with the water and an opposite end of which is coupled to the one end of the first body 100 such that the sterilization device 600 is located in the inner space; a filter 700 installed in a hole at one end of the second body 150 and configured to remove impurities when the water in the container 20 flows into the second body 150; and a discharge unit 800, one end of which is coupled to the discharge hole 151 such that the water sterilized in the second body 150 is discharged by movement of a valve 810 installed on one side thereof, wherein the water discharged from the container 20 filled with the water is discharged to the discharge unit 80 after the water is sterilized by the sterilization device 600 while the impurities are filtered by the filter 700, a user rotates the rotary shaft 310 and the rotary plate 320 with the handle 50, and the magnet 330 moves above the coil unit 400 according to rotation of the rotary plate 320 such that the coil unit 400 generates electricity, and the electricity generated by the coil unit 400 is transferred to the UV LED of the sterilization device 600 such that the UV rays for sterilizing the water in the interior of the second body 150 is emitted.

The present invention relates to a water-purifying lid 10 having a self-powered ultraviolet (UV) LED and a filter coupled thereto which includes first and second bodies 100 and 150, a support plate 200, a rotation unit 300, a coil unit 400, a handle 500, a sterilization device 600, a filter 700, and a discharge unit 800, and which allows a device that is supplied with electricity through self-power generation and emits UV rays to sterilize water once more after the impurities in the water in the drinkable water container are physically filtered so that the user can easily drink the water, and is economical because separate costs for producing electrical energy are not required.

Nowadays, the main cause of the deaths in the world is a water-borne disease. The populations of more than 2.3 billion are suffering from the diseases related to water and about 300 millions of people are suffering from dangerous diseases, and 2.3 millions of people, in particular, of children of less than five years old die every year (UN Task Force Water and Sanitary Facilities 2003). Almost of them live with less than 2 dollars every day, and the range of the technologies which may be provided to them for purification of water is extremely limited.

At the same time, the worldwide nations use many of the freshwater sources every year, and the possibility of obtaining safe drinkable water and the necessity for an efficient water purifying system are increasing. The UN population funds predict that 5 billion populations of the 7.9 billion populations in 2025 will live in the areas which lack safe water. The more unsatisfied demands on freshwater are requested in the developing countries. The average water consumption per one person in the developing countries is 2 gallons (7.7 liters) per person every day.

Many natural freshwater sources on the earth are contaminated by water-borne pathogenic bacteria. The lakes, the rivers, and the creeks in the world include bacteria, viruses, and protozoa that may generally cause severe health problems. The wells and the tube wells generally used as the freshwater sources in the world may be contaminated by the underground water in the rainy season in many areas of the world when the water-borne pathogenic bacteria are introduced into surface water, contaminating the wells. If the tube wells are badly constructed and badly maintained, the contaminated ground water may permeate into the wells on the more normal basis.

In order to utilize the contaminated water, many water purifying technologies range from the simple and inexpensive ones to the very complex and expensive ones are present, and the effect levels of the processing of the water-borne pathogenic bacteria, the organic contaminants, and the inorganic contaminants are distributed in a wide range. One simple and general technology is to boil water. In several areas of the world, because boiling requires a considerable amount of energy and the water is heated for a very short time, for which the water-borne pathogenic bacteria cannot be deactivated or sterilized, or has a possibility of not being heated until the water is completely boiled, it is not practical to be used every day.

Further, among the conventional water purifying systems, the prices per gallon of the many products are too high so that the products cannot be actually used in the developing countries.

The present invention has been suggested to solve the above-mentioned problems, and provides a water-purifying lid having a self-powered UV LED and a filter coupled thereto, which can easily sterilize and purify the water by coupling a device for emitting UV rays and a filter to the lid which blocks an inlet of a drinkable water container, and is economical because separate costs for producing electrical energy are not required by allowing the device which emits UV rays to receive electricity and emit light through self-powered generation.

According to the present invention, because the filter capable of physically removing the impurities is coupled to the lid, the impurities can be removed when the water in the water container is discharged through the lid, and the water can be easily purified by operating the UV LEDs, which are coupled to the lid, when the water is discharged through the lid. That is, according to the present invention, because the water-purifying lid having a self-powered UV LED and a filter coupled thereto is coupled to the container filled with the water, the discharged water can be processed physically and chemically and be converted to drinkable water so that people can easily drink water in underdeveloped nations, such as African countries, which undergo hunger. Further, according to the present invention, the user can directly generate electricity to allow the UV LEDs to emit light, and thus is economical because separate costs for producing electrical energy are not required. That is, because the UV LEDs can emit light through self-powered generation by using manpower, separate costs for allowing the UV LEDs to emit light are not required. Accordingly, the present invention is an invention which helps drink clear water with low costs in the underdeveloped nations, such as African countries, which undergo hunger. Further, according to the present invention, because the water flowing from the container into the lid becomes turbulent, a sterilization effect by the UV LEDs is high.

The first body 100 is a box-shaped member, one end of which is opened and the interior of which is empty. The first body 100 may be manufactured to have various shapes, and for example, has a cylindrical shape. The first body 100 may be formed of various materials if a required strength is satisfied.

The support plate 200 is a member which is installed in an inner space of the first body 100 to form a space for generating electricity. The support plate 200 is a plate installed to divide the interior space of the first body 100, and is a member manufactured in a sectional shape of the first body 100 and installed in the interior of the first body 100. The support plate 200 is a member which is installed in the interior of the first body 100 to form a space in which the rotation unit 300, which will be described below, may be installed. Further, two support plates 200 may be installed at an interval in the inner space of the first body 100 to form two independent spaces. That is, when two supports 200 are installed in the interior of the first body 100, the rotation unit 300 and the coil unit 400 are installed between the support plates 200 and the opposite end of the first body 100 and the storage battery 450 may be installed between the two support plates 200.

The support plates 200 may be formed of various materials if the required strength is satisfied.

The rotation unit 300 is adapted to produce electricity in the coil unit 400 by allowing the magnet to rotate above the coil unit 400 by a force applied from the outside, and may include a rotary shaft 310, a rotary plate 320, and a magnet 330.

The rotary shaft 310 is installed in the interior of the first body 100 to be rotated by an external force, and is a member, one end of which is coupled to the first body 100 to pass through the opposite end of the first body 100 to be rotated and an opposite end of which his coupled to the support plate 200 to be rotated. The rotary shaft 310 is a rod member-shaped shaft which is installed in the interior of the first body 100 and is rotated by a force applied from the outside. The rotary plate 320 is a member which has a circular plate shape and is installed such that the rotary shaft 310 passes through the center of the rotary plate 320 so that the rotary plate 320 is rotated about the rotary shaft 310 together with the rotary shaft 310 when the rotary shaft 310 is rotated. The magnet 330 is a member installed on an outer surface of the rotary plate 320. If the magnet 330 rotates about the coil unit 400, the magnetic force changes so that current may be generated in the coil of the coil unit 400. A plurality of magnets 330 may be installed on the outer surface of the rotary plate 320 at a predetermined interval, and for example, two magnets may be installed on each of opposite sides. The magnets 330 is permanent magnets.

The coil unit 400 is a member which is installed in the support plate 200 while a coil is wound on an outer peripheral surface of a pipe shape and generates electricity as the magnetic force is changed by the magnet 330. A coil of a sufficient size is wound on the coil unit 400 to allow the UV LEDs to emit light. One coil unit 400 may be installed above the support plate 200, or two coil units 400 may be installed on the upper and lower sides of the rotary plate 320, respectively, to increase electricity production efficiency.

The handle 500 is a member, one end of which is coupled to the one end of the rotary shaft 310 to apply a force such that the rotary shaft 310 is rotated. That is, the handle 500 has a configuration formed to apply a force to the rotary shaft 310 to produce electricity through self-powered generation by the user. The handle 500 is a member which is coupled to one end of the rotary shaft 310 to rotate the rotary shaft 310 even only with an action of gripping and rotating the rotary shaft 310. The handle 500 may be located at a site which may be reached by a hand of the user and be manufactured in various shapes to allow the user to easily apply a force. The handle 500 may be formed of various materials if the required strength is satisfied.

The sterilization device 600 emits heats such that UV rays are discharged after the electricity generated by the coil unit 400 is transferred to the UV LEDs and one end of the sterilization device 600 is coupled to the support plate 200. The sterilization device 600 is a member which is inserted into the opposite end of the second body 150 and installed in the interior of the second body 150 when the first body 100 is coupled to the second body 150. The sterilization device 600 is electrically connected to the coil unit 400 such that the electricity generated by the coil unit 400 is transferred to the UV LEDs, and has a configuration of emitting light to sterilize the water which has entered the second body 150. Further, the water becomes turbulent by the flows of the water flowing from the container into the lid so that a very high sterilization effect may be achieved by the sterilization device 600. The sterilization device 600 may have various configurations, and for example, may include a light emitting body 610 and a light emitter plate 620.

The light emitting body 610 has a configuration of being inserted into the second body 150 to submerge under the water and is a pipe-shaped member having a closed space in the interior thereof. The light emitter plate 620 is installed in the interior of the light emitting body 610 such that the electricity generated by the coil unit 400 is transferred to the light emitter plate 6120 to allow the LEDs to emit light, and is a member in which a plurality of UV LEDs are installed. The light emitter plate 620 is a board in which a plurality of UV LEDs are installed, and is a member to which the electricity generated by the coil unit 400 is transferred to allow the LEDs to emit light.

The second body 150 is a member, which has a discharge hole 151, through which water is discharged, on one side of an outer peripheral surface thereof, which has a pipe shape, opposite ends of which are opened, and one end of which is coupled to an inlet of the container 20 filled with the water and an opposite end of which is coupled to the one end of the first body 100 such that the sterilization device 600 is located in the inner space. That is, the second body 150 has a configuration of connecting the first body 100 and the container 20 filled with water, and is a site at which the water discharged from the container 20 is sterilized by the sterilization device 600. When the opposite end of the second body 150 is coupled to the one end of the first body 100, the sterilization device 600 coupled to the first body 100 is inserted into the second body 150 through a hole at the opposite end of the second body 150. The opposite ends of the second body 150 has a screw thread to be engaged with the screw thread of the first body 100 and the screw thread of the container 20 to prevent leakage of water. The discharge hole 151 is as hole which is formed on one side of the outer peripheral surface of the second body 150, and is a hole, into which the discharge unit 800, which will be described below, is inserted. Further, the second body 150 may further include an observation hole 152 formed to penetrate the outer peripheral surface of the second body 150, and a transparent plate 153 installed in the observation hole 152. The observation hole 152 is a hole that is formed to allow the user to easily recognize whether the sterilization device 600 is operated or not. The transparent plate 153 is a plate which prevents interior water from being discharged to the outside while the user watches the interior of the second body 150 through the observation hole 152.

The second body 150 may be formed of various materials if a required strength is satisfied.

The filter 700 is a member which is installed in a hole at one end of the second body 150 to remove impurities when the water in the container 20 flows into the second body 150. Various kinds of filters 700 having any configuration capable of removing impurities when the water flows into the interior of the second body 150 may be used. Further, the filter 700 has a configuration which is inserted into a hole at one end of the second body 150, and may be installed in various methods not to be moved by the flows of the water. That is, the filter 700 may be installed to be adhered to the hole at the one end of the second body 150 after a rubber ring is installed on the outer peripheral surface of the filter 700.

The discharge unit 800 is has a configuration, one end of which is coupled to the discharge hole 151 such that the water sterilized in the second body 150 is discharged by movement of a valve 810 installed on one side thereof. The discharge unit 800 functions as a faucet, and has a configuration which is generally used in the field of discharging water from a water purifier or a water container and discharges water as a valve 810 moves.

The present invention may further include a storage battery 450 which may store the electricity generated by the coil unit 400. In detail, according to the present invention, two support plates 200 are installed at a predetermined interval to form a space, and one of the two support plates 200 is electrically connected to the coil unit 400 and the other one of the two support plates 200 is connected to the sterilization device 600, and the water-purifying lid further comprises a storage battery 450 which is installed between the two support plates 200 and in which the electricity generated by the coil unit 400 is stored. The storage battery 450 is a site at which the electricity produced by the coil unit 400 is stored, and has a configuration of storing the electricity produced in advance and sending the electricity to the sterilization device 600 if necessary. Various forms of storage batteries 450 having any configuration capable of storing electricity may be used.

The present invention may further include a controller 900 which switches on or off the sterilization device 600. In more detail, the present invention may further include a controller 900 connected (electrically connected: not illustrated) to the sterilization device 600 to switch on or off the electricity flowing to the sterilization device 600 according to a control signal and installed in the first body 100 or the handle 500. The controller 900 is adapted to switch on or off the electricity applied the sterilization device 600 and may be variously manufactured, and for example, may be manufactured in the form of a switch to control emission of light by the UV LEDs by switching on or off the electricity applied to the sterilization device 600.

The present invention may further include a third body 170, which has a pipe shape, opposite ends of which are opened, and one end of which is coupled to the one end of the second body 150 and an opposite end of which is coupled to an inlet of the container filled with the water. The third body 170 has a configuration of connecting the second body 150 and the container 20 filled with water, and is configured such that the size of one end thereof varies according the size of the inlet of the container 20, to which the second body 170 is coupled. That is, according to the present invention, because the third body 170 which is an intermediate connector of various sizes is selected according to the size of the inlet of various containers 20 to connect the second body 150 and the container 20 filled with the water, one ‘water-purifying lid having a self-powered ultraviolet (UV) LED and a filter coupled thereto’ may be used for containers 20 of various sizes. The opposite ends of the third body 170 has a screw thread to be engaged with the screw thread of the second body 150 and the screw thread of the container 20 to prevent leakage of water. The third body 170 may be formed of various materials if a required strength is satisfied.

Although the preferred embodiments of the water-purifying lid having a self-powered ultraviolet (UV) LED and a filter coupled thereto according to the present invention have been described until now, they are described just as one or more embodiments, and the technical spirit, the configuration, and the operation of the present invention are not limited by the embodiments and the range of the technical spirit of the present invention is not limited/restricted by the drawings and the detailed description of the present invention made with reference to the drawings. Further, the concepts and the embodiments suggested by the present invention may be used by an ordinary person in the part to which the present invention pertains as the basis for correcting or designing the present invention to other structures to perform the same purpose of the present invention, and the equivalent structures corrected or modified by an ordinary person in the art to which the present invention pertains are restricted by the technical range of the present invention claimed in the claims and the present invention can be variously changed, replaced, and changed without departing from the spirit or range of the present invention claimed in the claims.

1. A water-purifying lid having a self-powered ultraviolet (UV) LED and a filter coupled thereto, the water-purifying lid being usable for an apparatus for sterilizing water contained in a container such that the water is drinkable when the water is discharged, the water-purifying lid comprising:
a first body (100), which has a box shape and one end of which is opened;
a support plate (200) installed in an inner space of the first body (100) to form a space;
a rotation unit (300) including a rotary shaft (310) which is installed in the interior of the first body (100) to be rotated by an external force, and one end of which passes through an opposite end of the first body (100) and is coupled to the opposite end of the first body (100) to be rotatable and an opposite end of which is coupled to the support plate (200) to be rotatable, a rotary plate (320) being a plate-shaped member, installed on one side of the rotary shaft (310), and rotated according to rotation of the rotary shaft (310), and a magnet (330) installed on an outer surface of the rotary plate (320);
a coil unit (400) installed in the support plate (200) such that a coil is wound thereon to have a predetermined shape, and configured to generate electricity as a magnetic force is changed by the magnet (330);
a handle (500), one end of which is coupled to the one end of the rotary shaft (310) and configured to apply a force such that the rotary shaft (310) is rotated;
a sterilization device (600), which emits heats such that UV rays are discharged after the electricity generated by the coil unit (400) is transferred to the UV LED and one end of which is coupled to the support plate (200);
a second body (150), which has a discharge hole (151), through which water is discharged, on one side of an outer peripheral surface thereof, which has a pipe shape, opposite ends of which are opened, and one end of which is coupled to an inlet of the container filled with the water and an opposite end of which is coupled to the one end of the first body (100) such that the sterilization device (600) is located in the inner space;
a filter (700) installed in a hole at one end of the second body (150) and configured to remove impurities when the water in the container (20) flows into the second body (150); and
a discharge unit (800), one end of which is coupled to the discharge hole (151) such that the water sterilized in the second body (150) is discharged by movement of a valve (810) installed on one side thereof,
wherein the water discharged from the container (20) filled with the water is discharged to the discharge unit (800) after the water is sterilized by the sterilization device (600) while the impurities are filtered by the filter (700), a user rotates the rotary shaft (310) and the rotary plate (320) with the handle (500), and the magnet (330) moves above the coil unit (400) according to rotation of the rotary plate (320) such that the coil unit (400) generates electricity, and the electricity generated by the coil unit (400) is transferred to the UV LED of the sterilization device (600) such that the UV rays for sterilizing the water in the interior of the second body (150) is emitted.

2. The water-purifying lid of claim 1, wherein two support plates (200) are installed at a predetermined interval to form a space, and one of the two support plates (200) is connected to the coil unit (400) and another one of the two support plates (200) is connected to the sterilization device (600), and wherein the water-purifying lid further comprises a storage battery (450) which is installed between the two support plates (200) and in which the electricity generated by the coil unit (400) is stored.

3. The water-purifying lid of claim 1 or 2, further comprising:
a controller (900) connected to the sterilization device (600) to switch on or off the electricity flowing to the sterilization device (600) according to a control signal and installed in the first body (100) or the handle (500).

4. The water-purifying lid of claim 1, wherein the second body (150) further includes:
an observation hole (152) formed on one side of an outer peripheral surface of the second body (150) to penetrate the outer peripheral surface of the second body (150); and
a transparent plate (153) installed in the observation hole (152), and
wherein the user is able to easily recognize whether the sterilization device (600) is operated, through the observation hole (152).

5. The water-purifying lid of claim 1, wherein the sterilization device (600) includes:
a pipe-shaped light emitting body (610) having a closed space in the interior thereof; and
a light emitter plate (620), which is installed in the interior of the light emitting body (610) such that the electricity generated by the coil unit (400) is transferred to the LED to allow the LED to emit light and in which a plurality of UV LEDs are installed.

6. The water-purifying lid of claim 1, further comprising:
a third body (170), which has a pipe shape, opposite ends of which are opened, and one end of which is coupled to the one end of the second body (150) and an opposite end of which is coupled to an inlet of the container filled with the water,
wherein the third body (170) is selected depending on the size of the inlet of the container (20) coupled thereto, and connects the second body (150) and the container (20).
